(19) United States
(12) Patent Application Publication
(10) Pub. No.: US 2026/0133353 A1
(43) Pub. Date: May 14, 2026

(54) NANOSTRUCTURE LAYER, COLOR FILTER STRUCTURE COMPRISING THE SAME, AND METHOD OF MANUFACTURING THE SAME

(71) Applicant: VisEra Technologies Company Limited, Hsin-Chu City (TW)

(72) Inventors: Nung-Che CHENG, Hsin-Chu City (TW); Huang-Jen CHEN, Hsin-Chu City (TW); Han-Sheng CHEN, Hsin-Chu City (TW); Shin-Hong KUO, Hsin-Chu City (TW); Jian-Wen LAI, Hsin-Chu City (TW)

(21) Appl. No.: 18/947,706

(22) Filed: Nov. 14, 2024

(51) Int. Cl. G02B 5/20; B82Y 20/00; G02B 1/00

(52) U.S. Cl. CPC G02B 5/206; B82Y 20/00; G02B 1/002

(57) ABSTRACT

A nanostructure layer includes a nano light pillar structure and a first optical structure disposed on the nano light pillar structure. The nano light pillar structure includes a nano light pillar and a connected cavity surrounding the nano light pillar, and the first optical structure includes a first index matching layer.

### BACKGROUND OF THE INVENTION

### Field of the Invention

The present invention relates to a nanostructure layer, a color filter structure comprising the nanostructure layer, and a method of manufacturing the color filter structure.

### Description of the Related Art

Nano light pillars are a light-channeling form of metasurface capable of directing specific wavelengths of light to detector pixels that are best suited to receive the light. The nano light pillars will enhance visible optical performance of CIS (CMOS Image Sensor) in different applications, such as mobile phones, automobiles and security systems. Compared with micro lenses, nano light pillars can provide better quantum efficiency (QE) of pixels. However, the quantum efficiency of conventional nanopillars declines too quickly at wide angles of incidence.

### BRIEF SUMMARY OF THE INVENTION

The disclosure provides a nanostructure layer and a color filter structure. The nanostructure layer and the color filter structure are capable of providing a continuous angle variety and an improved angular response in wide angle range by covering a nano light pillar structure having an irregular pillar array with an optical structure, thereby forming a connected cavity surrounding nano light pillars in the irregular pillar array.

An embodiment of the present invention provides a nanostructure layer including a nano light pillar structure and a first optical structure disposed on the nano light pillar structure. The nano light pillar structure includes a nano light pillar and a connected cavity surrounding the nano light pillar, and the first optical structure includes a first index matching layer.

An embodiment of the present invention provides a color filter structure including a color filter layer and a nanostructure layer disposed on the color filter layer. The nanostructure layer includes a first optical structure disposed on the color filter layer and a nano light pillar structure disposed between the color filter layer and the first optical structure. The first optical structure includes a first index matching layer. The nano light pillar structure includes a nano light pillar and a connected cavity surrounding the nano light pillar.

In addition, an embodiment of the present invention provides a method of manufacturing a color filter structure including a nanostructure layer. The method of manufacturing a color filter structure including a nanostructure layer includes: providing a nano light pillar structure wafer including a nano light pillar structure on a color filter layer; forming a first optical pre-structure on the nano light pillar structure wafer; and forming a first optical structure from the first optical pre-structure. The first optical structure includes a first index matching layer. A connected cavity surrounding the nano light pillar is formed after forming a first optical pre-structure on the nano light pillar structure wafer.

### BRIEF DESCRIPTION OF THE DRAWINGS

The present invention can be more fully understood by reading the subsequent detailed description and examples with references made to the accompanying drawings, wherein:

FIG. 1A is a schematic cross-sectional view of a nanostructure layer according to an embodiment of the present disclosure;

FIG. 1B is a schematic cross-sectional view of a nanostructure layer according to an embodiment of the present disclosure;

FIG. 1C is a schematic cross-sectional view of a nanostructure layer according to an embodiment of the present disclosure;

FIG. 1D is a schematic cross-sectional view of a nanostructure layer according to an embodiment of the present disclosure;

FIG. 2 is a schematic cross-sectional view of a color filter structure according to an embodiment of the present disclosure;

FIG. 3A is a schematic cross-sectional view of a color filter structure according to another embodiment of the present disclosure;

FIG. 3B is a schematic exploded view of the color filter structure of FIG. 3A;

FIG. 4 is a schematic cross-sectional view of a color filter structure according to another embodiment of the present disclosure;

FIG. 5 is a schematic cross-sectional view of a color filter structure according to another embodiment of the present disclosure;

FIG. 6 is a schematic cross-sectional view of a color filter structure according to another embodiment of the present disclosure;

FIG. 7 is a schematic cross-sectional view of a color filter structure according to another embodiment of the present disclosure;

FIG. 8 is a schematic cross-sectional view of a color filter structure according to another embodiment of the present disclosure;

FIG. 9 is a flowchart of a method of manufacturing a color filter structure including a nanostructure layer according to an embodiment of the present disclosure;

FIG. 10A is a schematic cross-sectional view of a nano light pillar structure wafer according to an embodiment of the present disclosure;

FIG. 10B is a schematic top view of the nano light pillar structure wafer of FIG. 10A;

FIG. 10C is a schematic cross-sectional view of a first optical structure substrate according to an embodiment of the present disclosure;

FIG. 10D is a schematic cross-sectional view of a semi-finished product in a method of manufacturing a color filter structure including a nanostructure layer according to an embodiment of the present disclosure;

FIG. 10E is a schematic cross-sectional view of a product (color filter structures) of a method of manufacturing a color filter structure including a nanostructure layer according to an embodiment of the present disclosure;

FIG. 10F is a schematic cross-sectional view of a semi-finished product in a method of manufacturing a color filter structure including a nanostructure layer according to an embodiment of the present disclosure;

FIG. 10G is a schematic cross-sectional view of products (color filter structures) of a method of manufacturing a color filter structure including a nanostructure layer according to an embodiment of the present disclosure;

FIG. 11 is a diagram illustrating an angle of incidence of light relative to an angle of exit of light after light has passed through first optical structures of the present disclosure having different refractive indices. ; and

FIGS. 12A to 12C are diagrams illustrating angular responses of light incidence of color filter structures.

### DETAILED DESCRIPTION OF THE INVENTION

The following description is made for the purpose of illustrating the general principles of the disclosure and should not be taken in a limiting sense. The scope of the disclosure is determined by reference to the appended claims. Reference will now be made in detail to exemplary embodiments of the present disclosure, examples of which are illustrated in the accompanying drawings. Whenever possible, the same reference numbers are used in the drawings and descriptions to refer to the same or similar parts.

The directional terms mentioned in the disclosure, such as “up”, “down”, “front”, “back”, “left”, “right” only refer to the directions of the accompanying drawings. Therefore, the directional terms used herein are illustrative and not intended to limit the disclosure. It should be understood that if a device in an accompanying drawing is turned so that it is upside down, elements recited on the “bottom” side will become the elements on the “top” side. In the accompanying drawings, the drawings illustrate general features of the methods, structures and/or materials used in specific embodiments. However, these accompanying drawings should not be construed as defining or limiting the scope or property of what is covered by these embodiments. For example, relative sizes, thicknesses and positions of the various layers, regions and/or structures may be reduced or enlarged for clarity.

In the present disclosure, descriptions of a structure (or layer, element or substrate) being on/above another structure (or layer, element or substrate) may mean that the two structures are adjacent and directly connected, or that the two structures are adjacent and indirectly connected. Indirect connection means that there is at least one intermediate structure (or intermediate layer, intermediate element, intermediate substrate, intermediate spacer) between two structures. A lower surface of the structure is adjacent to or directly connected to an upper surface of the intermediate structure, and an upper surface of the other structure is adjacent to or directly connected to a lower surface of the intermediate structure. The intermediate structure may be a single-layer or multi-layer physical structure or a non-physical structure without limitation. In the disclosure, when a structure is disposed “on” another structure, it may mean that the structure is “directly” on the other structure, or that the structure is “indirectly” on the other structure, i.e. there is at least one structure is between the structure and the other structure.

In the disclosure, the terms “about”, “equal to”, “equal” or “the same”, “substantially” or “approximately” usually indicates a value of a given value or range that varies within 20%, or a value of a given value or range that varies within 10%, within 5%, or within 3%, or within 2%, or within 1%, or within 0.5%.

Ordinal numbers used in the specification and claims, such as “first”, “second”, etc., are used to modify elements. The ordinal numbers do not imply or represent numbers of the element (or elements). The ordinal numbers do not represent the order of one element over another or the order of manufacturing method. The ordinal numbers are only used to clearly distinguish two elements having the same name. The claims and the specification may not use the same terms. Therefore, the first element in the specification may be the second element in the claim.

It should be understood that according to the embodiments of the present disclosure, the depth, thickness, width or height of each element, or the space of the elements or the distance between them may be measured using an optical microscope (OM), a scanning electron microscope (SEM), a film thickness profile measuring gauge (α-step), an elliptical thickness gauge, or other suitable measurement methods. According to some embodiments, a scanning electron microscope and focused ion beam (FIB) may be used to obtain a cross-sectional structural image including the elements to be measured, and to measure the depth, thickness, width or height of each element, or the space or distance between the elements. In particular, the scanning electron microscope can be used to locate a position where the cross-sectional structural image is to be taken, the FIB can be used to excavate the exact location where the cross-sectional structural image is to be taken, and the scanning electron microscope is then used to obtain the sectional structural image after the excavation has been completed.

Unless otherwise defined, all terms (including technical and scientific terms) used herein have the same meaning as commonly understood by a person skilled in the art to which the disclosure pertains. It will be further understood that terms, such as those defined in commonly used dictionaries, should be interpreted as having a meaning consistent with the relevant technology and the context or background of this disclosure and will not be interpreted in an idealized or overly formal sense unless expressly so defined herein.

The term “schematic cross-sectional view” herein refers to a schematic view intercepted along a normal direction (the Z direction) of a nanostructure layer and/or a color filter structure.

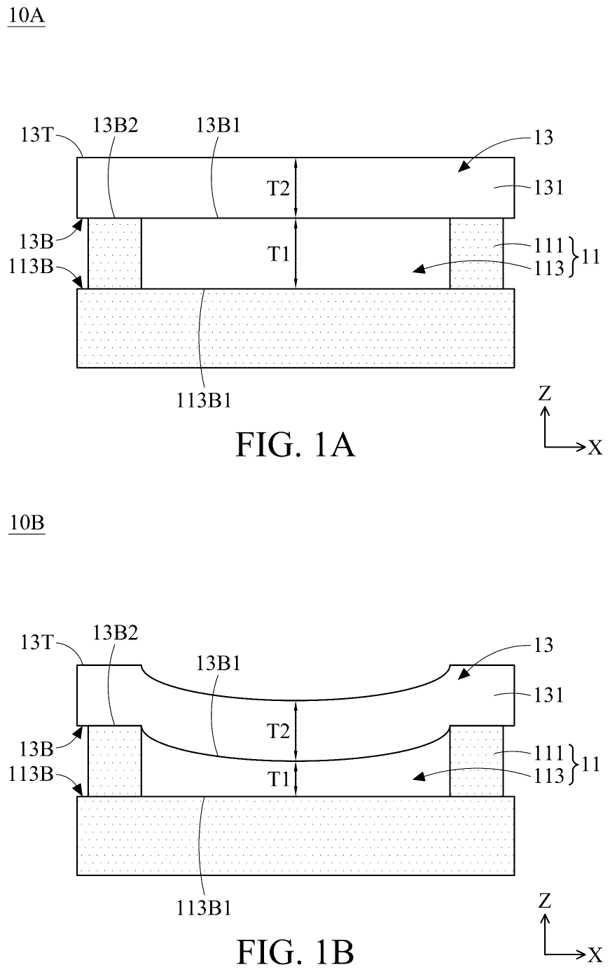

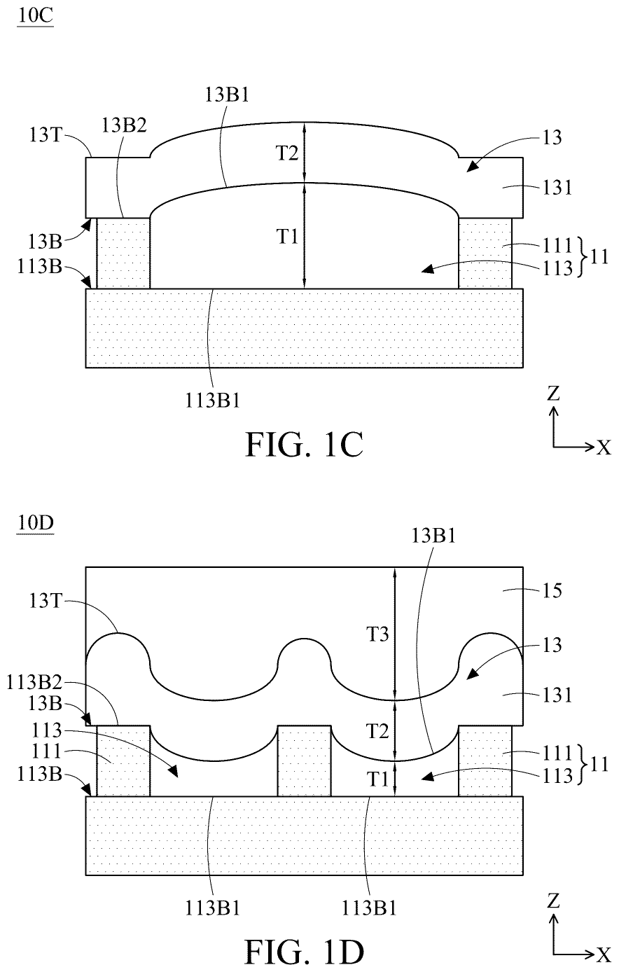

An aspect of the present disclosure is providing a nanostructure layer. The nanostructure layer includes a nano light pillar structure including a nano light pillar and a connected cavity surrounding the nano light pillar, and a first optical structure disposed on the nano light pillar structure and including a first index matching layer. FIGS. 1A to 1D are schematic cross-sectional views of nanostructure layers 10A to 10D according to embodiments of the present disclosure. As shown in FIGS. 1A to 1D, each of the nanostructure layers 10A to 10D includes a nano light pillar structure 11 and a first optical structure 13 disposed on the nano light pillar structure 11.

The nano light pillar structure 11 including a nano light pillar 111 and a connected cavity 113 surrounding the nano light pillar 111. A material of the nano light pillar 111 may include a transparent photoresist, an organic material, an oxide, an acrylic material, a plastic, other suitable materials, or any combination thereof. In some embodiments, the nano light pillar structure 11 includes a plurality of nano light pillars 111, and the nano light pillars 111 may be arranged in an irregular array or in a regular array. The connected cavity 113 surrounds the nano light pillars 111 and separates the nano light pillars 111 from each other. In other words, the nano light pillars 111 are disposed in the connected cavity 113 and separated from each other by a distance. The connected cavity 113 has a cavity bottom surface 113B, and the nano light pillar 111 is disposed on the cavity bottom surface 113B. The portion of the cavity bottom surface 113B on which the nano light pillar 111 is not disposed is referred to as the flat bottom area 113B1 of the connected cavity 113. In some embodiments, the connected cavity 113 may be filled with air or may be vacuum, as shown in FIGS. 1A to 1D, but the disclosure is not limited thereto. In some embodiments, the first optical structure 13 may fill up the connected cavity 113 of the nano light pillar structure 11. When the connected cavity 113 is filled with air, a pressure in the connected cavity 113 may be equal to, less than, or greater than atmospheric pressure (about 101,315 pa).

The first optical structure 13 including a first index matching layer 131 is disposed on and covers the entire of the nano light pillar structure 11. That is, the first index matching layer 131 may be disposed on and covers the nano light pillar 111 and covering the connected cavity 113. The first optical structure 13 has a top surface 13T and a bottom surface 13B between the top surface 13T and the nano light pillar structure 11. The bottom surface 13B has a first portion 13B1 corresponding to the flat bottom area 113B1 of the connected cavity 113 and a second portion 13B2 corresponding to (and bonded to) the nano light pillar 111. In the embodiment that the connected cavity 113 is filled with air, the first portion 13B1 of the bottom surface 13B may be flat, concave, convex, or free-form. For example, in the embodiment that a pressure in the connected cavity 113 is equal to atmospheric pressure, the first portion 13B1 of the bottom surface 13B of the first optical structure 13 of the nanostructure layer 10A may be flat as shown in FIG. 1A. In the embodiment that a pressure in the connected cavity 113 is less than atmospheric pressure, the first portion 13B1 of the bottom surface 13B of the first optical structure 13 of the nanostructure layer 10B may be concave or free-form as shown in FIGS. 1B and 1D. In the embodiment that a pressure in the connected cavity 113 is greater than atmospheric pressure, the first portion 13B1 of the bottom surface 13B of the first optical structure 13 of the nanostructure layer 10C may be convex or free-form as shown in FIGS. 1C and 1D. A volume of the connected cavity 113 when the pressure in the connected cavity 113 is less than atmospheric pressure is smaller than a volume of the connected cavity 113 when the pressure in the connected cavity 113 is equal to atmospheric pressure. A volume of the connected cavity 113 when the pressure in the connected cavity 113 is greater than atmospheric pressure is greater than a volume of the connected cavity 113 when the pressure in the connected cavity 113 is equal to atmospheric pressure.

In the embodiment that the connected cavity 113 is filled with air, a distance T1 between the flat bottom area 113B1 and the first optical structure 13 is greater than 10 nm and less than 1 um. The distance T1 is equal to a distance between the flat bottom area 113B1 and the first portion 13B1 of the bottom surface 13B. In some embodiments, the distance T1 is equal to a height of the nano light pillar 111 in the normal direction (the Z direction) of a nanostructure layer. The distance T1 may be variable or constant. In particular, referring to FIG. 1A, in the embodiment that the first portion 13B1 of the bottom surface 13B is flat, the distance T1 between the flat bottom area 113B1 and the first optical structure 13 may be constant, and may be greater than 10 nm and less than 1 um. Referring to FIGS. 1B to 1D, in the embodiment that the first portion 13B1 of the bottom surface 13B is concave, convex, or free-form, the distance T1 between the flat bottom area 113B1 and the first optical structure 13 may be variable between 10 nm and 1 um, but not be 10 nm and 1 um.

The first optical structure 13 may include a first index matching layer 131, and the first index matching layer 131 may has a substantially flat (or substantially smooth) surface as shown in FIGS. 1A to 1D, but the disclosure is not limited thereto. In some embodiments, the first index matching layer 131 has a thickness T2, and the thickness T2 may be greater than 50 nm and less than 100 um. That is, in some embodiment, the first optical structure 13 has a thickness T2 greater than 50 nm and less than 100 um. In some embodiments, the first optical structure 13 may further include a first nanostructure on the first index matching layer 131, and the first nanostructure may have a microlens array structure, a pyramid array structure, a cone array structure, or any combination thereof. In some embodiments, in the cross-sectional view of the nanostructure layer, a profile of the first nanostructure may include triangles, top-flat triangles, parabolics, top-flat parabolics, or any combination thereof. That is, a cross-sectional profile of the first nanostructure may include triangles, top-flat triangles, parabolics, top-flat parabolics, or any combination thereof.

In the embodiments that the first optical structure 13 include a first nanostructure having a microlens array structure, a pyramid array structure, or a cone array structure, a shortest distance between two adjacent microlens, two adjacent pyramids, or two adjacent cones in a plane perpendicular to the normal direction (the Z direction) of a nanostructure layer is defined as a distance d1. In some embodiments, the distance d1 is less than 1 um. In the embodiments that a cross-sectional profile of the first nanostructure may include triangles, top-flat triangles, parabolics, or top-flat parabolics, a distance between a vertex or a top and a base of the triangle, the top-flat triangle, the parabolic, or the top-flat parabolic in the normal direction of a nanostructure layer is defined as a height h1. A width of the base of the triangle, the top-flat triangle, the parabolic, or the top-flat parabolic in a direction perpendicular to the normal direction of a nanostructure layer is defined as a base width w1. A width of the top of the top-flat triangle or the top-flat parabolic in a direction perpendicular to the normal direction of a nanostructure layer is defined as a top width w2. The distance d1 may be the same as or different from the base width w1. The top width w2 is shorter than the base width w1. In some embodiments, the height h1 is greater than 10 nm and less than 1 um. In some embodiments, the base width w1 is less than 2 um.

Based on the structure of the first nanostructure, the top surface 13T of the first optical structure 13 may be a microlens array surface, a pyramid array surface, a cone array surface, or any combination thereof.

In some embodiments, the first optical structure 13 includes a dielectric material having a thermoplastic adhesive or laser ablation properties. In some embodiments, the first optical structure 13 may include a photoresist, a thermosetting material, a photosetting material, an acrylic material, a plastic, other suitable materials, or any combination thereof. In some embodiments, the first optical structure 13 may fill up the connected cavity 113 of the nano light pillar structure 11. In the embodiment that the first optical structure 13 fills up the connected cavity 113 of the nano light pillar structure 11, the first optical structure 13 may include a material having a refractive index greater than 1.1 and less than 1.9. In some embodiments, the first optical structure 13 may include a material having a refractive index greater than 1.1 and less than 1.6. In some embodiments, the first index matching layer 131 of the first optical structure 13 may fill up the connected cavity 113 of the nano light pillar structure 11. In this embodiments, the first index matching layer 131 may include a first index matching material having a refractive index greater than 1.1 and less than 1.9, but the disclosure is not limited thereto. In some embodiments, the first index matching layer 131 may include a first index matching material having a refractive index greater than 1.1 and less than 1.6. In the embodiments that the first optical structure 13 includes more than one index matching layers, and the index matching layers may have the same or different index matching materials. In the embodiments that the first optical structure 13 includes the first nanostructure, the first nanostructure may include a material having a refractive index greater than 1.1 and less than 1.9 or a material having a refractive index greater than 1.1 and less than 1.6. In some embodiments, the first index matching material is the same as the material included in the first nanostructure, but the disclosure is not limited thereto.

In some embodiments, the nanostructure layer may further include a second optical structure including a second index matching layer on the first optical structure 13, and the first optical structure 13 is between the second optical structure and the nano light pillar structure 11. Structure of the second index matching layer may be substantially the same as that of the first index matching layer 131. Therefore, the structure of the second index matching layer will not be repeated here. The second index matching layer may include a second index matching material having a refractive index greater than 1.1 and less than 1.9, but the disclosure is not limited thereto. In some embodiments, the second index matching layer may include a second index matching material having a refractive index greater than 1.1 and less than 1.6. The second index matching material may be the same as or different from the first index matching material. In some embodiment, the second optical structure may further include a second nanostructure on the second index matching layer. Structure of the second nanostructure may be substantially the same as that of the first nanostructure. Therefore, the structure of the second nanostructure will not be repeated here. The structures of the first optical structure 13 and the second optical structure may be the same or different from each other. For example, in some embodiment, the nanostructure layer may include a first optical structure 13 without the first nanostructure and a second optical structure with a second nanostructure having a microlens array structure, a pyramid array structure, or a cone array structure. In some embodiment, the nanostructure layer may include a first optical structure 13 having a material having a refractive index greater than 1.1 and less than 1.9 and a second optical structure having a material having a refractive index greater than 1.1 and less than 1.6.

In some embodiments, the nanostructure layer may further include a flat layer 15 on the first optical structure 13, as shown in FIG. 1D. In the embodiment that the nanostructure layer includes a second optical structure, the flat layer 15 may be on the second optical structure, and the second optical structure may be between the first optical structure 13 and the flat layer 15. The flat layer 15 may have a thickness T3 in the normal direction of a nanostructure layer, and the thickness T3 may be greater than 50 nm and less than 100 um. A material of the flat layer 15 may include but is not limited to a transparent photoresist, an organic material, an oxide, an acrylic material, a plastic, other suitable materials, or any combination thereof.

In some embodiments, the nanostructure layer may further include a passivation layer between the nano light pillar structure 11 and the first optical structure 13. In some embodiment, the passivation layer may be disposed between the nano light pillar 111 of the nano light pillar structure 11 and the first optical structure 13. A material of the passivation layer may include oxides, for example, silicon oxide, but the disclosure is not limited thereto.

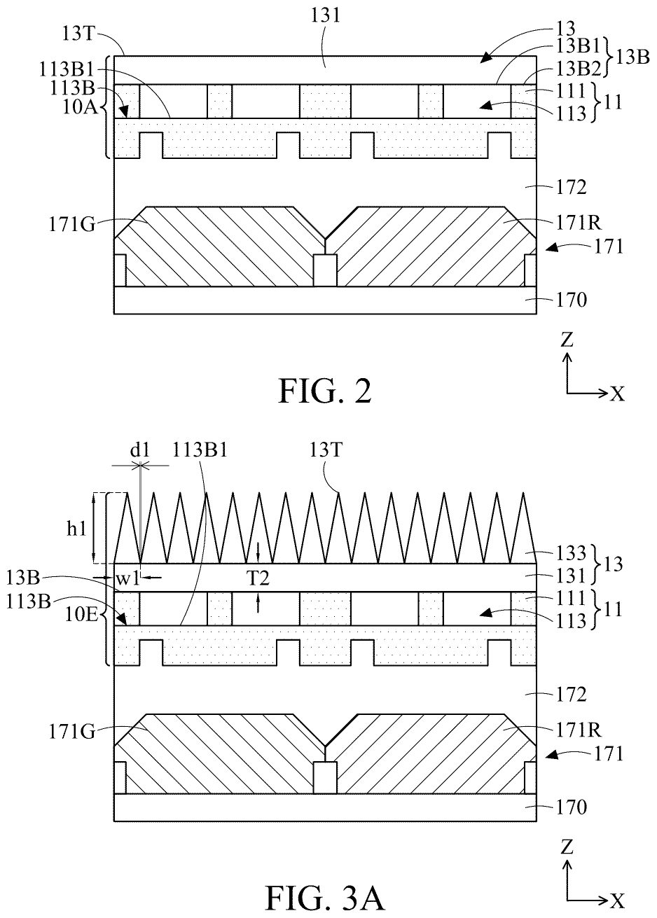

An aspect of the present disclosure is providing a color filter structure. The color filter structure includes a color filter layer and a nanostructure layer disposed on the color filter layer. The nanostructure layer includes a first optical structure disposed on the color filter layer, and a nano light pillar structure between the color filter layer and the first optical structure. The first optical structure includes a first index matching layer and the nano light pillar structure includes a nano light pillar and a connected cavity surrounding the nano light pillar. FIG. 2 is a schematic cross-sectional view of a color filter structure according to an embodiment of the present disclosure.

Referring to FIG. 2, a color filter structure of the present disclosure includes a color filter layer 171 and the nanostructure layer 10A mentioned above.

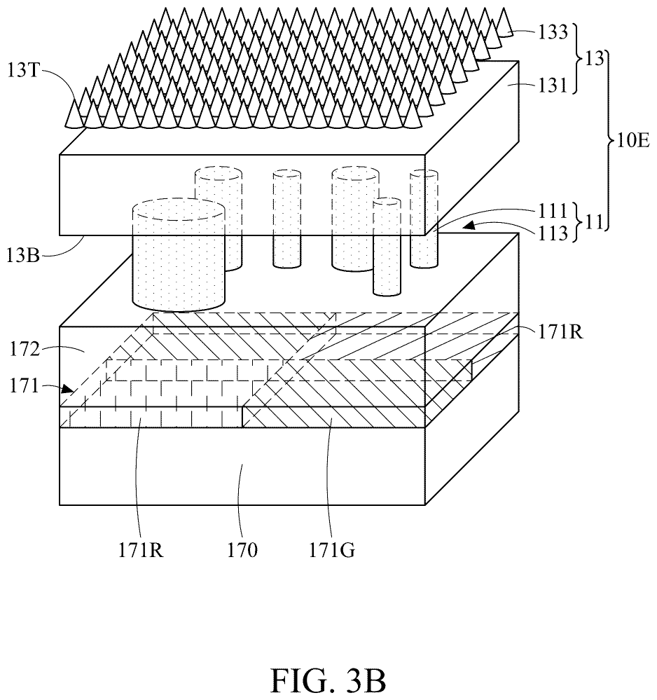

The color filter layer 171 is disposed under the nanostructure layer 10A. In some embodiments, the color filter layer 171 may include a blue filter 171B (as shown in FIG. 3B), a green filter 171G, and a red filter 171R, but the disclosure is not limited thereto. In some embodiment, the color filter layer 171 may include a blue filter, a green filter, a red filter, and a white filter.

In some embodiment, the color filter structure may further include a first buffer layer 170 and a second buffer layer 172. The color filter layer 171 may be disposed between the first buffer layer 170 and the second buffer layer 172, and the second buffer layer 172 may be disposed between the color filter layer 171 and the nanostructure layer 10A, as shown in FIG. 2. A material of the first buffer layer 170 and the second buffer layer 172 may include a transparent photoresist, an organic material, an oxide, an acrylic material, a plastic, other suitable materials, or any combination thereof.

FIG. 3A is a schematic cross-sectional view of a color filter structure according to another embodiment of the present disclosure, and FIG. 3B is a schematic exploded view of the color filter structure of FIG. 3A. Except that the color filter structure of FIG. 3A includes a nanostructure layer 10E instead of the nanostructure layer 10A, the structure of the color filter structure of FIGS. 3A and 3B is substantially the same as that of the structure of the color filter structure of FIG. 2. The nanostructure layer 10E is described below with reference to FIGS. 3A and 3B.

As shown in FIG. 3 A and 3B, the nanostructure layer 10E includes a nano light pillar structure 11 and a first optical structure 13 disposed on the nano light pillar structure 11. The nano light pillar structure 11 including a nano light pillar 111 and a connected cavity 113 surrounding the nano light pillar 111, wherein the connected cavity 113 is filled with air and a pressure in the connected cavity 113 may be equal to atmospheric pressure. The first optical structure 13 of the nanostructure layer 10E has a top surface 13T and a bottom surface 13B. The bottom surface 13B has a first portion 13B1 corresponding to the flat bottom area 113B1 of the connected cavity 113 and a second portion 13B2 corresponding to (and bonded to) the nano light pillar 111, and the first portion 13B1 and the second portion 13B2 of the bottom surface 13B of the nanostructure layer 10E are both flat.

Referring to FIG. 3B, the first optical structure 13 of the nanostructure layer 10E includes a first index matching layer 131 and a first nanostructure 133 having a cone array structure on the first index matching layer 131. Based on the structure of the first nanostructure 133 of the nanostructure layer 10E, the top surface 13T of the first optical structure 13 is a cone array surface. A cross-sectional profile of the first nanostructure 133 of the nanostructure layer 10E may include triangles, as shown in FIG. 3A. Furthermore, according to the cross-sectional profile of the first nanostructure 133 of the nanostructure layer 10E, a distance d1 between two adjacent triangles is less than 1 um, a height h1 of each of the triangles is greater than 10 nm and less than 1 um, and a base width w1 of each of the triangles is less than 2 um.

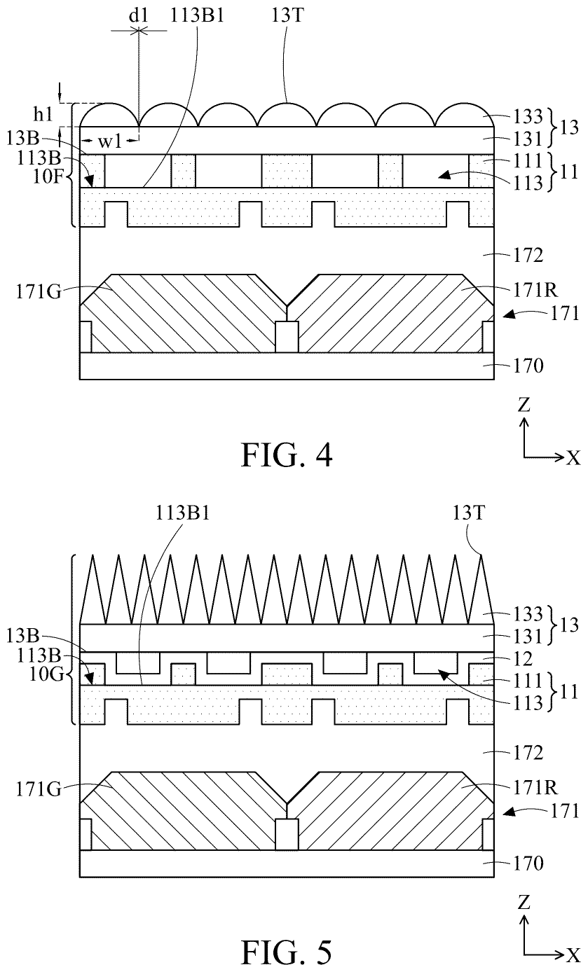

FIG. 4 is a schematic cross-sectional view of a color filter structure according to another embodiment of the present disclosure. Except that the color filter structure of FIG. 4 includes a nanostructure layer 10F instead of the nanostructure layer 10E, the structure of the color filter structure of FIG. 4 is substantially the same as that of the structure of the color filter structure of FIGS. 3A and 3B.

The difference between the nanostructure layer 10F and nanostructure layer 10E is that the first nanostructure 133 of the nanostructure layer 10F having a microlens array structure instead of a cone array structure. Therefore, based on the structure of the first nanostructure 133 of the nanostructure layer 10F, the top surface 13T of the first optical structure 13 is a microlens array surface. A cross-sectional profile of the first nanostructure 133 of the nanostructure layer 10F may include parabolics, as shown in FIG. 4. Furthermore, according to the cross-sectional profile of the first nanostructure 133 of the nanostructure layer 10F, a distance d1 between two adjacent parabolics is less than 1 um, a height h1 of each of the parabolics is greater than 10 nm and less than 1 um, and a base width w1 of each of the parabolics is less than 2 um.

FIG. 5 is a schematic cross-sectional view of a color filter structure according to another embodiment of the present disclosure. Except that the color filter structure of FIG. 5 includes a nanostructure layer 10G instead of the nanostructure layer 10E, the structure of the color filter structure of FIG. 5 is substantially the same as that of the structure of the color filter structure of FIGS. 3A and 3B.

The difference between the nanostructure layer 10F and nanostructure layer 10E is that the nanostructure layer 10F further include a passivation layer 12 disposed between the nano light pillar structure 11 and the first optical structure 13 to protect the nano light pillar structure 11. In particular, the passivation layer 12 disposed between the nano light pillar structure 11 and the first optical structure 13 covers a top surface and a side surface of the nano light pillar 111, and the flat bottom area 113B1 of the connected cavity 113 as shown in FIG. 5. A material of the passivation layer 12 may include oxides, for example, silicon oxide, but the disclosure is not limited thereto.

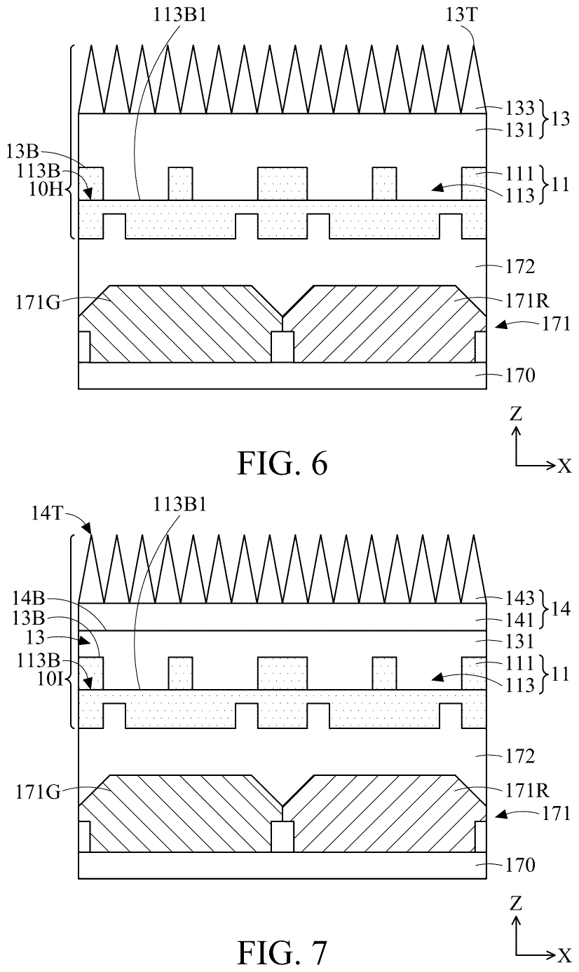

FIG. 6 is a schematic cross-sectional view of a color filter structure according to another embodiment of the present disclosure. Except that the color filter structure of FIG. 6 includes a nanostructure layer 10H instead of the nanostructure layer 10E, the structure of the color filter structure of FIG. 6 is substantially the same as that of the structure of the color filter structure of FIGS. 3A and 3B.

The difference between the nanostructure layer 10H and nanostructure layer 10E is that the first optical structure 13 fills up the connected cavity 113 of the nano light pillar structure 11. In particular, in the nanostructure layer 10H, the first index matching layer 131 of the first optical structure 13 may fill up the connected cavity 113 of the nano light pillar structure 11. In this embodiment, the first optical structure 13 in the connected cavity 113 may include a material having a refractive index greater than 1.1 and less than 1.9. In the nanostructure layer 10H, the first index matching layer 131 in the connected cavity 113 may include a first index matching material having a refractive index greater than 1.1 and less than 1.9. The first nanostructure 133 may include a material having a refractive index greater than 1.1 and less than 1.9 or a material having a refractive index greater than 1.1 and less than 1.6. In some embodiments, a material included in the first nanostructure 133 may be the same as the first index matching material.

FIG. 7 is a schematic cross-sectional view of a color filter structure according to another embodiment of the present disclosure. Except that the color filter structure of FIG. 7 includes a nanostructure layer 10I instead of the nanostructure layer 10A, the structure of the color filter structure of FIG. 7 is substantially the same as that of the structure of the color filter structure of FIG. 2.

The difference between the nanostructure layer 10I and nanostructure layer 10A is that the nanostructure layer 10I further include a second optical structure 14 on the first optical structure 13 and the first optical structure 13 fills up the connected cavity 113 of the nano light pillar structure 11. The nanostructure layer 10I is described below with reference to FIG. 7.

As shown in FIG. 7, the nanostructure layer 10I includes a nano light pillar structure 11 and a first optical structure 13 disposed on the nano light pillar structure 11. The nano light pillar structure 11 including a nano light pillar 111 and a connected cavity 113 surrounding the nano light pillar 111, wherein the first optical structure 13 fills up the connected cavity 113 of the nano light pillar structure 11. In some embodiments, in the nanostructure layer 10I, the first index matching layer 131 of the first optical structure 13 may fill up the connected cavity 113 of the nano light pillar structure 11. In this embodiment, the first optical structure 13 in the connected cavity 113 may include a material having a refractive index greater than 1.1 and less than 1.9. In some embodiments, in the nanostructure layer 10I, the first index matching layer 131 in the connected cavity 113 may include a first index matching material having a refractive index greater than 1.1 and less than 1.9, and the first nanostructure 133 may include a material having a refractive index greater than 1.1 and less than 1.9 or a material having a refractive index greater than 1.1 and less than 1.6. In some embodiments, a material included in the first nanostructure 133 may be the same as the first index matching material.

The second optical structure 14 including a second index matching layer 141 and a second nanostructure 143 having a cone array structure on the second index matching layer 141 is disposed on the first optical structure 13 as shown in FIG. 7. Based on the structure of the second nanostructure 143 of the nanostructure layer 10I, a top surface 14T of the second optical structure 14 is a cone array surface. A cross-sectional profile of the second nanostructure 143 of the nanostructure layer 10I may include triangles, as shown in FIG. 7. Furthermore, according to the cross-sectional profile of the second nanostructure 143 of the nanostructure layer 10I, a distance between two adjacent triangles is about less than 1 um, a height of each of the triangles is greater than 10 nm and less than 1 um, and a base width of each of the triangles is less than 2 um.

In some embodiment, a bottom surface 14B of the second optical structure 14 may be above the nano light pillar structure 11, and the second optical structure 14 may not fill up the connected cavity 113 of the nano light pillar structure 11, but the disclosure is not limited thereto. In this embodiment, the second optical structure 14 may include a material having a refractive index greater than 1.1 and less than 1.6. In some embodiments, in the nanostructure layer 10I, the second index matching layer 141 of the second optical structure 14 may include a second index matching material having a refractive index greater than 1.1 and less than 1.6, and the second nanostructure 143 may include a material having a refractive index greater than 1.1 and less than 1.6. In some embodiments, a material included in the second nanostructure 143 may be the same as the second index matching material.

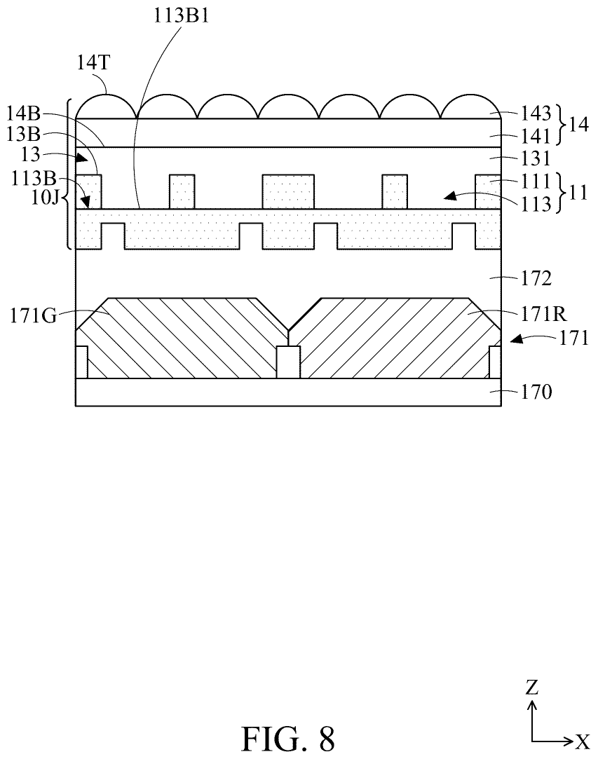

FIG. 8 is a schematic cross-sectional view of a color filter structure according to another embodiment of the present disclosure. Except that the color filter structure of FIG. 8 includes a nanostructure layer 10J instead of the nanostructure layer 10I, the structure of the color filter structure of FIG. 8 is substantially the same as that of the structure of the color filter structure of FIG. 7.

The difference between the nanostructure layer 10J and nanostructure layer 10I is that the second nanostructure 143 of the nanostructure layer 10J having a microlens array structure instead of a cone array structure. Therefore, the structure of color filter structure of FIG. 8 will not be repeated here.

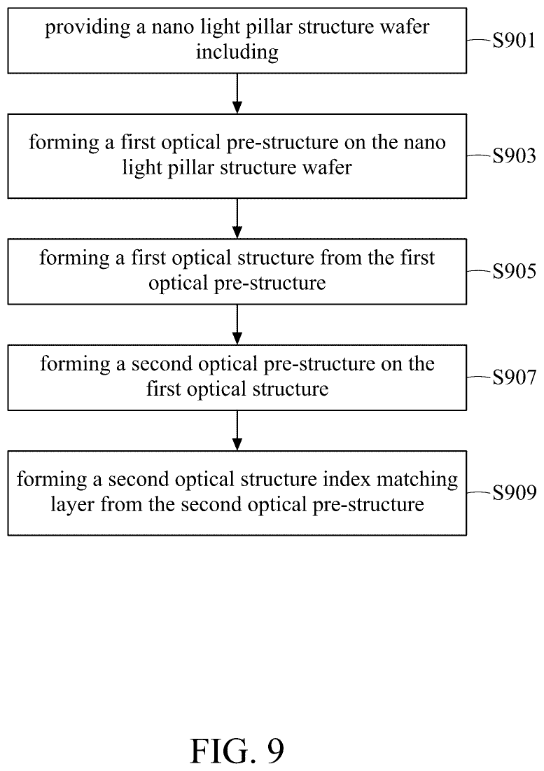

An aspect of the present disclosure is providing a method of manufacturing a color filter structure including a nanostructure layer. FIG. 9 is a flowchart of a method of manufacturing a color filter structure including a nanostructure layer according to an embodiment of the present disclosure. As shown in FIG. 9, the method of manufacturing a color filter structure including a nanostructure layer of the present disclosure includes: a step S901 of providing a nano light pillar structure wafer; a step S903 of forming a first optical pre-structure on the nano light pillar structure wafer; and a step S905 of forming a first optical structure from the first optical pre-structure. After the step S905, the nanostructure layer is formed.

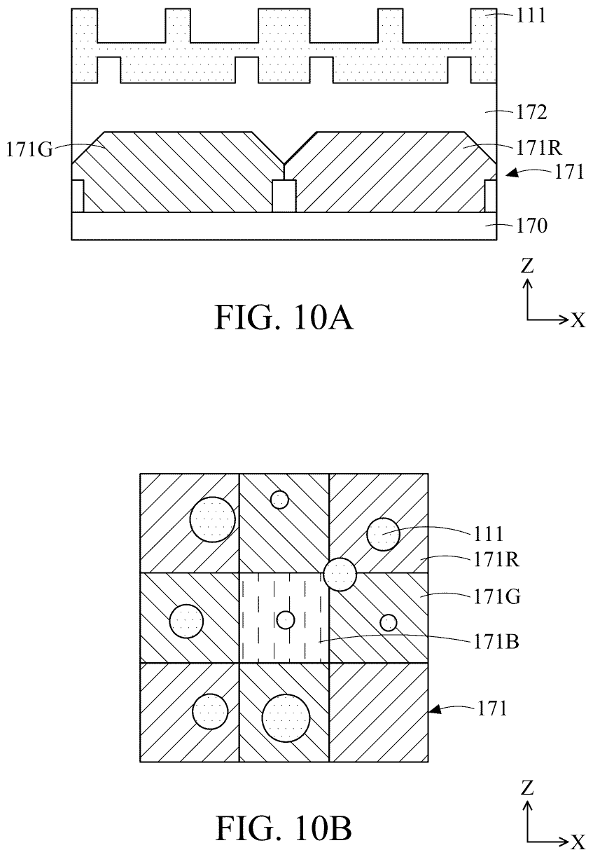

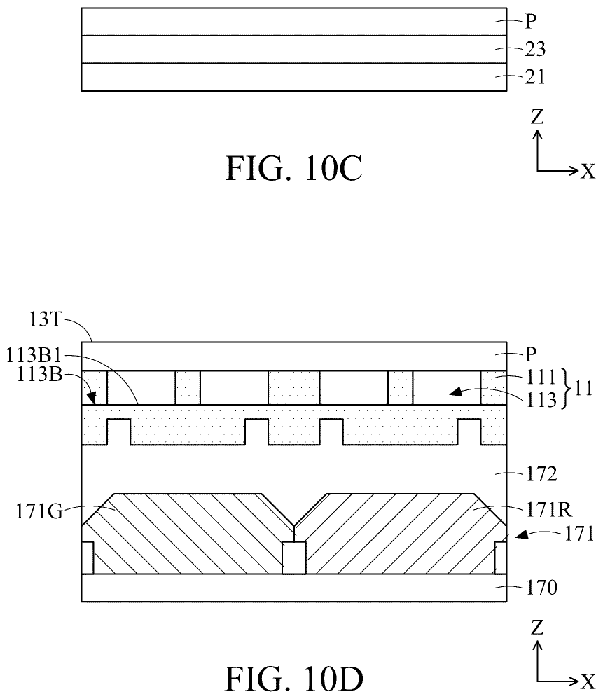

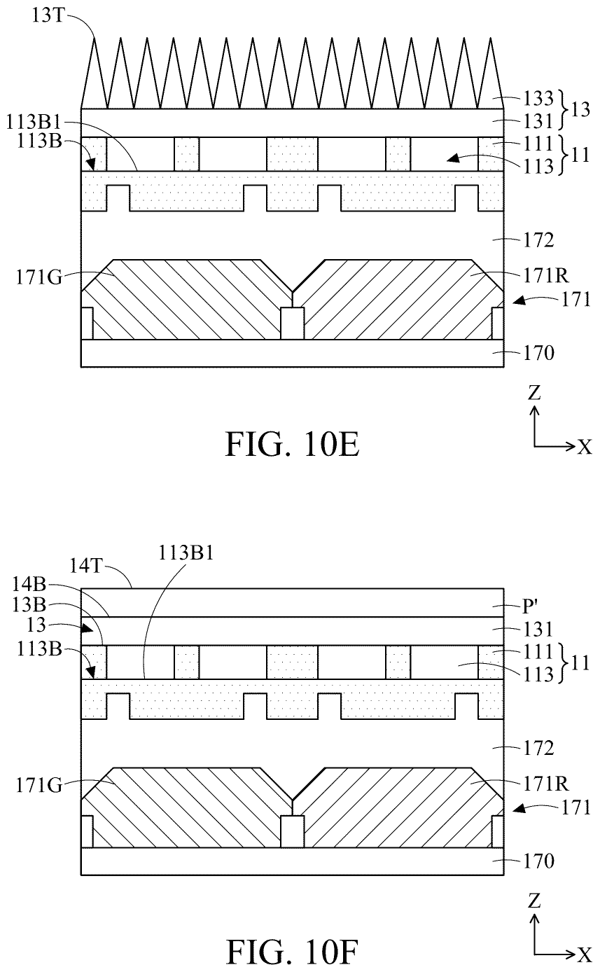

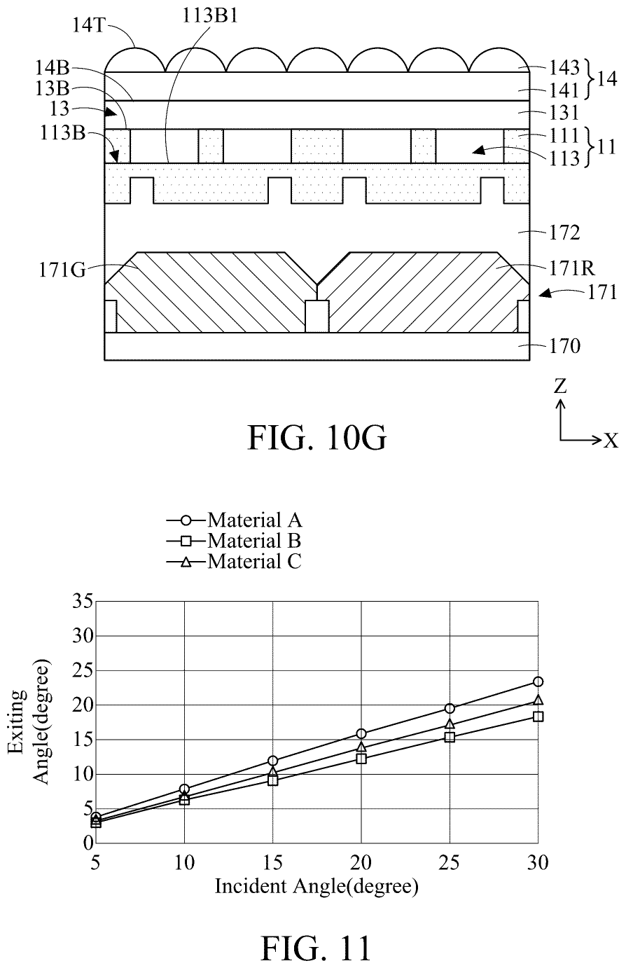

In some embodiments, the nano light pillar structure wafer provided in the step S901 may has a structure shown in FIGS. 10A and 10B. FIG. 10A is a schematic cross-sectional view of a nano light pillar structure wafer according to an embodiment of the present disclosure. FIG. 10B is a schematic top view of the nano light pillar structure wafer of FIG. 10A. Referring to FIG. 10A, the nano light pillar structure wafer includes nano light pillars 111 and a color filter layer 171 under the nano light pillars 111. As shown in FIG. 10B, the nano light pillars 111 are arranged in an irregular array and base areas of each the nano light pillars 111 may be the same or different from each other, but the disclosure is not limited thereto. In some embodiment, the nano light pillars 111 may be arranged in a regular array.

The color filter layer 171 may include a blue filter 171B, a green filter 171G, and a red filter 171R as shown in FIG. 10B, but the disclosure is not limited thereto. In some embodiment, the color filter layer 171 may include a blue filter, a green filter, a red filter, and a white filter. In some embodiment, the nano light pillar structure wafer may further include a first buffer layer 170 and a second buffer layer 172. The color filter layer 171 may be disposed between the first buffer layer 170 and the second buffer layer 172, and the second buffer layer 172 may be disposed between the color filter layer 171 and the nano light pillars 111 as shown in FIG. 10A.

In the step S903, a first optical pre-structure is formed on the nano light pillar structure wafer shown in FIGS. 10A and 10B, thereby forming a connected cavity surrounding the nano light pillar the nano light pillars 111 of the nano light pillar structure wafer. The step of forming the first optical pre-structure on the nano light pillar structure wafer may include providing a first optical structure substrate, bonding the first optical structure substrate to the nano light pillar structure wafer, and removing the release layer and the temporary substrate of the first optical structure substrate.

FIG. 10C is a schematic cross-sectional view of a first optical structure substrate according to an embodiment of the present disclosure. As shown in FIG. 10C, the first optical structure substrate includes a temporary substrate 21, a first optical pre-structure P on the temporary substrate 21, and a release layer 23 between the first optical pre-structure P and the temporary substrate 21. The step of providing the first optical structure substrate may include forming the release layer 23 on the temporary substrate 21 and forming the first optical pre-structure P on the release layer 23. The method for forming the first optical pre-structure P and the release layer 23 may include but not limited to a spin coating process, a screen printing process, a chemical vapor deposition process, a physical vapor deposition process, an ink jet printing process, a slot coating process, other suitable methods, or any combination thereof. The first optical structure substrate shown in FIG. 10C is bonded to the nano light pillar structure wafer shown in FIG. 10A by any suitable method in the step of bonding the first optical structure substrate to the nano light pillar structure wafer. After the first optical structure substrate has been bonded to the nano light pillar structure wafer, the release layer 23 and the temporary substrate 21 may be removed by laser, heat, other suitable methods, or any combination thereof in the step of removing a release layer and a temporary substrate of the first optical structure substrate. The first optical pre-structure P is left on the nano light pillar structure wafer and a connected cavity 113 surrounding the nano light pillar 111 is formed after removing a release layer and a temporary substrate. The structure obtained after the step S903 may be shown as FIG. 10D. FIG. 10D is a schematic cross-sectional view of a semi-finished product in a method of manufacturing a color filter structure including a nanostructure layer according to an embodiment of the present disclosure.

A first optical structure 13 may be formed from the first optical pre-structure P in the step S905. In some embodiment, the structure obtained after the step S905 may be shown as FIG. 2,but the disclosure is not limited thereto. In some embodiment, the structure obtained after the step S905 may be as shown in FIG. 10E. FIG. 10E is a schematic cross-sectional view of a product (color filter structures) of a method of manufacturing a color filter structure including a nanostructure layer according to an embodiment of the present disclosure. Referring to FIG. 10E, the first optical structure 13 includes a first index matching layer 131 and a first nanostructure 133 on the first index matching layer 131. In this embodiment, the step S905 may further include a first nanostructure forming process, which is a process for forming the first nanostructure 133 on the first index matching layer 131. The first nanostructure forming process may include a hard mask, a lithography process, and an etching process, but the disclosure is not limited thereto. In some embodiments, the first nanostructure forming process may include a nano imprint lithography process. In some embodiments, the color filter structure of the present disclosure may be completed after the step S905, but the disclosure is not limited thereto.

In some embodiments, the method of manufacturing a color filter structure including a nanostructure layer of the present disclosure may further include a step S907 of forming a second optical pre-structure on the first optical structure and a step S909 of forming a second optical structure from the second optical pre-structure.

In some embodiments, the step S907 may be performed after the first optical structure 13 is formed. For ease of explanation, the structure obtained after the step S905 is as shown in FIG. 2 is used as an example. A second optical pre-structure P′ may be formed on the structure of FIG. 2 obtained after the step S905. FIG. 10F is a schematic cross-sectional view of a semi-finished product in a method of manufacturing a color filter structure including a nanostructure layer according to an embodiment of the present disclosure. Referring to FIG. 10F, a second optical pre-structure P′ is formed on the first optical structure 13. The step S907 is substantially the same as step S903, and thus the step S907 will not be repeated here.

The step S909 may be performed after the step S907. The step S909 is substantially the same as step S905, and thus the step S909 will not be repeated here. In some embodiments, the color filter structure of the present disclosure may be completed after the step S909, but the disclosure is not limited thereto. FIG. 10G is a schematic cross-sectional view of a product (color filter structures) of a method of manufacturing a color filter structure including a nanostructure layer according to an embodiment of the present disclosure. Referring to FIG. 10G, the color filter structure of the present disclosure obtained after the step S909 may include a second nanostructure 143 having a microlens array structure, wherein a cross-sectional profile of the second nanostructure 143 may include parabolics, but the disclosure is not limited thereto. In some embodiments, the color filter structure of the present disclosure obtained after the step S909 may include a second nanostructure 143 having a microlens array structure, wherein a cross-sectional profile of the second nanostructure 143 may include top-flat parabolics.

In some embodiments, the method of manufacturing a color filter structure including a nanostructure layer according to an embodiment of the present disclosure may further include forming a passivation layer on the nano light pillars 111 of the nano light pillar structure wafer before the step S903. In some embodiments, the passivation layer may be formed by a spin coating process, a screen printing process, a chemical vapor deposition process, a physical vapor deposition process, an ink jet printing process, a slot coating process, other suitable methods, or any combination thereof.

The nanostructure layer and the color filter structure having the above structure can provide a continuous angle variety and an improved angular response in wide angle range.

The color filter structure of FIG. 3A and the nano light pillar structure wafer of FIG. 10A are used as examples to illustrate the advantages of the present disclosure. are measure below to illustrate the advantages of the present disclosure.

### Angle Variety Measure

A light receiving surface is placed under the first optical structure of the present disclosure having different refractive indices. A parallel light is used to simulate light having different angles of incidence. The change in the angle of incidence of the light relative to an exit angle of the light after the light has passed through the first optical structures of the present disclosure is observed and the result is shown in FIG. 11. FIG. 11 is a diagram illustrating an angle of incidence of light relative to an angle of exit of light after light has passed through first optical structures of the present disclosure made of a material A, a material B, and a material C, wherein the material A has a refractive index of 1.3, the material B has a refractive index of 1.6, and the material C has a refractive index of 1.5. Referring to FIG. 11, it is clear that a light is refracted when passing through the color filter structure of the present disclosure. Accordingly, the first optical structure of the present disclosure can provide an angle variety, and the color filter structure of the present disclosure including the nanostructure layer can provide an angle variety.

### Angular Responses Measure

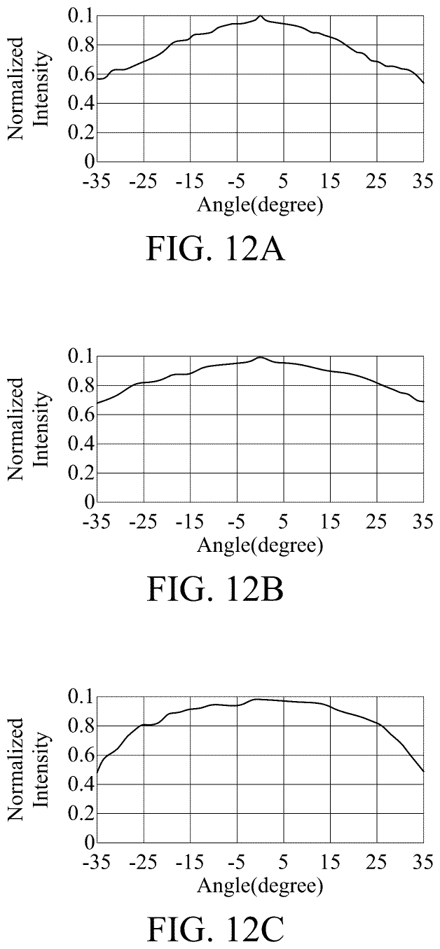

A light receiving surface is placed under the first optical structure of the present disclosure having different refractive indices. A parallel light is used to simulate light having different angles of incidence. The energy change when light is incident on different nano light pillar structure wafers at different angles is observed and the result is shown in FIGS. 12A to 12C. FIGS. 12A to 12C are diagrams illustrating angular responses of light incidence of color filter structures. FIG. 12A is a diagram illustrating angular responses of light incidence of the nano light pillar structure wafer shown in FIG. 10A. FIG. 12B is a diagram illustrating angular responses of light incidence of the color filter structure shown in FIG. 3A. FIG. 12C is a diagram illustrating angular responses of light incidence of a comparative color filter structure. Except that the comparative color filter structure includes a nanostructure layer 10G without the nano light pillar structure 11, the structure of the comparative color filter structure is substantially the same as that of the structure of the color filter structure of FIG. 3A. That is, the comparative color filter structure includes a color filter layer and a first optical structure on the color filter layer. The first optical structure of the comparative color filter structure has a first index matching layer and a first nanostructure having a microlens array structure on the first index matching layer, and there is no nano light pillar structure disposed between the first optical structure and the color filter layer of the comparative color filter structure. Refractive indices of the first optical structures of the color filter structure shown in FIG. 3A and the comparative color filter structure are both 1.3.

Referring to FIGS. 12A to 12C, it is clear that the nanostructure layer of the present disclosure can provide an angle variety, and the color filter structure of the present disclosure including the nanostructure layer can provide an improved angular response in wide angle range.

Accordingly, the nanostructure layer of the present disclosure and the color filter structure including the same can provide a continuous angle variety and an improved angular response in wide angle range.

Although embodiments of the present disclosure and the advantages thereof have been disclosed as described above, it should be understood that changes, substitutions and modifications may be made without departing from the spirit and scope of the disclosure. In addition, the protection scope of the present disclosure is not limited to the processes, machines, fabrications, compositions, devices, methods and steps in the specific embodiments described in the specification. According to the embodiments of the present disclosure, a person of ordinary skill in the art may understand that current or future processes, machines, fabrications, compositions, devices, methods and steps capable of performing substantially the same functions or achieving substantially the same results may be used in the embodiments of the present disclosure. Therefore, the protection scope of the present disclosure includes the above-mentioned processes, machines, fabrications, compositions, devices, methods and steps. In addition, features of different embodiments may be used together arbitrary as long as they do not violate the spirit of the disclosure or conflict with each other. Each claim constitutes an individual embodiment, and the protection scope of the present disclosure includes the combination of the claims and embodiments.

What is claimed is:

1. A nanostructure layer, comprising:
a nano light pillar structure comprising a nano light pillar and a connected cavity surrounding the nano light pillar; and
a first optical structure disposed on the nano light pillar structure and comprising a first index matching layer.

2. The nanostructure layer as claimed in claim 1, wherein the connected cavity has a flat bottom area, and a distance T1 between the flat bottom area and the first optical structure is greater than 10 nm and less than 1 um.

3. The nanostructure layer as claimed in claim 2, wherein the first optical structure has a top surface and a bottom surface between the top surface and the nano light pillar structure, and a portion of the bottom surface corresponding to the flat bottom area of the connected cavity is flat, concave, convex, or free-form.

4. The nanostructure layer as claimed in claim 1, wherein the nano light pillar structure comprises a plurality of nano light pillars, and the plurality of nano light pillars are separated by the connected cavity.

5. The nanostructure layer as claimed in claim 1, wherein the first optical structure has a thickness T2, and the thickness T2 is greater than 50 nm and less than 100 um.

6. The nanostructure layer as claimed in claim 1, further comprising a flat layer on the first optical structure, wherein a thickness T3 of the flat layer is greater than 50 nm and less than 100 um.

7. The nanostructure layer as claimed in claim 1, wherein the first optical structure further comprises a first nanostructure on the first index matching layer, and the first nanostructure comprising a microlens array structure, a pyramid array structure, a cone array structure or any combination thereof.

8. The nanostructure layer as claimed in claim 1, wherein the first optical structure fills up the connected cavity, and has a material having a refractive index greater than 1.1 and less than 1.9.

9. The nanostructure layer as claimed in claim 1, further comprising a second optical structure, wherein the first optical structure is between the second optical structure and the nano light pillar structure, the second optical structure comprises a second index matching layer and a second nanostructure on the second index matching layer, and the second nanostructure comprises a microlens array structure, a pyramid array structure, a cone array structure or any combination thereof.

10. The nanostructure layer as claimed in claim 1, further comprising a second optical structure comprising a second index matching layer, wherein the first optical structure is between the second optical structure and the nano light pillar structure, fills up the connected cavity, and has a material having a refractive index greater than 1.1 and less than 1.9, and the second optical structure has a material having a refractive index greater than 1.1 and less than 1.6.

11. The nanostructure layer as claimed in claim 1, wherein the first optical structure further comprises a first nanostructure on the first index matching layer, the first index matching layer comprises a first index matching material, and a material of the first nanostructure is the same as the first index matching material.

12. The nanostructure layer as claimed in claim 1, further comprising a passivation layer between the nano light pillar structure and the first optical structure.

13. The nanostructure layer as claimed in claim 1, wherein the first optical structure comprises a dielectric material having a thermoplastic adhesive or laser ablation properties.

14. A color filter structure, comprising:
a color filter layer;
a nanostructure layer disposed on the color filter layer, the nanostructure layer comprising:
a first optical structure disposed on the color filter layer and comprising a first index matching layer; and
a nano light pillar structure disposed between the color filter layer and the first optical structure, wherein the nano light pillar structure comprises a nano light pillar and a connected cavity surrounding the nano light pillar.

15. A method of manufacturing a color filter structure comprising a nanostructure layer, comprising:
providing a nano light pillar structure wafer comprising a nano light pillar on a color filter layer;
forming a first optical pre-structure on the nano light pillar structure wafer, thereby forming a connected cavity surrounding the nano light pillar; and
forming a first optical structure comprising a first index matching layer from the first optical pre-structure to form the nanostructure layer.

16. The method of manufacturing a color filter structure comprising a nanostructure layer as claimed in claim 15, wherein forming a first optical pre-structure on the nano light pillar structure wafer comprises:
providing a first optical structure substrate, wherein the first optical structure substrate comprises a temporary substrate, the first optical pre-structure on the temporary substrate, and a release layer between the temporary substrate and the first optical pre-structure;
bonding the first optical structure substrate to the nano light pillar structure wafer; and
removing the release layer and the temporary substrate of the first optical structure substrate.

17. The method of manufacturing a color filter structure comprising a nanostructure layer as claimed in claim 15, wherein the first optical structure further comprises a first nanostructure on the first index matching layer, and a forming process for the first optical structure comprises forming the first nanostructure using a hard mask, a lithography process, and an etching process.

18. The method of manufacturing a color filter structure comprising a nanostructure layer as claimed in claim 15, wherein the first optical structure further comprises a first nanostructure, and the forming process for the first optical structure comprises forming the first nanostructure using a nano imprint lithography process.

19. The method of manufacturing a color filter structure comprising a nanostructure layer as claimed in claim 15, further comprising forming a second optical pre-structure on the first optical structure and forming a second optical structure comprising a second index matching layer from the second optical pre-structure.

20. The method of manufacturing a color filter structure comprising a nanostructure layer as claimed in claim 15, wherein the first optical structure has a top surface and a bottom surface between the top surface and the nano light pillar structure wafer, and a portion of the bottom surface corresponding to a flat bottom area of the connected cavity is flat, concave, convex, or free-form.
